(19) United States
(12) Patent Application Publication
(10) Pub. No.: US 2008/0233469 A1
(43) Pub. Date: Sep. 25, 2008

(54) BATTERY MANAGEMENT SYSTEM

(75) Inventors: Piotr Drozdz, Vancouver (CA); Lorne Edward Gettel, Vancouver (CA); Stewart Neil Simmonds, Coquitlam (CA)

Correspondence Address: SEED INTELLECTUAL PROPERTY LAW GROUP PLLC, 701 FIFTH AVE, SUITE 5400, SEATTLE, WA, 98104, US

(73) Assignee: ADVANCED LITHIUM POWER INC., Vancouver (CA)

(21) Appl. No.: 12/029,246

(22) Filed: Feb. 11, 2008

Related U.S. Application Data
(60) Provisional application No. 60/900,355, filed on Feb. 9, 2007.

(51) Int. Cl. H01M 6/02; H01M 10/48

(52) U.S. Cl. 429/61; 429/91

(57) ABSTRACT

Disclosed herein is a battery management system for lithium ion batteries capable of determining a battery pack's state of capacity; determining a battery pack's state of charge limits; adjusting for voltage drops and power losses over a battery's internal and/or connector impedances; adjusting the upper and lower voltage limits of a battery pack; and of actively balancing the cells making up the battery pack. In order to achieve this functionality, the battery pack management system includes an electronic control unit, which unit is coupled to module and cell-level circuitry that is designed to measure operating conditions of the battery such as voltage and current at any given time.

### FIELD OF THE INVENTION

This invention relates generally to energy storage devices and to systems and methods related thereto, and more particularly to a lithium ion battery management system.

### BACKGROUND OF THE INVENTION

Batteries used in hybrid electric vehicles (“HEVs”) currently include lead acid batteries, nickel metal hydride batteries, and lithium ion batteries, with each type of battery having its own operating characteristics and limitations. Lithium ion batteries, for example, have a relatively high energy and power density, thereby allowing a lithium ion battery of a certain capacity to be significantly smaller and lighter than a lead acid or nickel metal hydride battery of the same capacity. While this is one benefit of using lithium ion batteries, lithium ion batteries must also be monitored during use to ensure that they, and the cells contained therein, are maintained within certain operating conditions. For example, lithium ion cells must not be over or undercharged, as such improper charging can result in negative consequences such as sub-optimal power output, shortened cell lifespan, serious cell damage, and other potential hazards.

Lithium ion batteries used in an HEV should usually be charged to between 20% and 80% of their capacity. This allows the battery to always have enough power so as to be able to provide power during acceleration, yet have enough free capacity so as to be able to capture energy from regenerative braking. Consequently, an accurate state of capacity (“SoAh”) reading is important to ensure optimal functioning of lithium ion batteries. One problem that has to be addressed in this regard is the voltage drops at high currents across the internal impedances of a lithium ion battery, as such drops result in inaccuracies in SoAh calculations.

Another exemplary problem encountered when using lithium ion batteries is ensuring that the individual cells that make up the battery are always charged to approximately the same capacity while in use. Otherwise, those cells charged to lesser capacities will discharge prematurely and can cause the entire battery to become inoperable.

Yet another exemplary problem encountered when using lithium ion batteries is determining the state of charge (“SOC”) of the battery at any given time, where SOC is expressed as a percentage of total charge. Determining the SOC of a battery is affected by the internal impedance of the cells that make up the battery, for example, the effect of which should be compensated for if an accurate SOC reading is desired.

Such problems are not adequately addressed by battery management systems known in the prior art. Consequently, there exists a need to provide an improved battery management system that overcomes at least one of the deficiencies of the prior art.

### SUMMARY OF THE INVENTION

Accordingly, it is an object of the invention to provide a battery management system that addresses at least one of the deficiencies in the prior art.

A series of battery cells are organized into modular units with onboard microprocessors and sensors. These circuits monitor and regulate module voltages and temperatures, charge and discharge characteristics, and actively balance module states of charge throughout a battery system. Each module is part of a network employing an automotive-grade data bus connected to an electronic control unit (ECU). The ECU regulates the battery charging rate, cooling rate, and power output depending on load requirements and feedback from the sensors and circuits on each module.

By means of the sensors and measurement circuitry on each module, and governed by the ECU, the battery management system is adapted to adjust for variations in any one or more of SoAh, SOC limits, cell impedances, upper and lower voltage limits, and is also capable of active cell balancing.

### BRIEF DESCRIPTION OF THE DRAWINGS

FIG. 1 shows an illustrative isometric view of a module composed of six cells and a printed circuit board (“PCB”) mounting plate, according to one embodiment of the invention;

FIG. 2a shows an illustrative isometric rear view of the module according to one embodiment of the invention;

FIG. 2b shows an illustrative bottom view of the module showing how a PCB fits to the PCB mounting plate, and also illustrates a different pattern of cell connectors, according to one embodiment of the invention;

FIG. 3 shows an illustrative isometric view of a bank of modules according to one embodiment of the invention;

FIG. 4 shows an illustrative isometric rear view of a battery assembly according to one embodiment of the invention;

FIG. 5a shows an illustrative isometric rear view of fan mounting according to one embodiment of the invention;

FIG. 5b shows an illustrative isometric front view of a battery assembly & fan mounting according to one embodiment of the invention;

FIG. 6 shows a block diagram of a circuit designed to measure the SoAh of cells according to one embodiment of the invention;

FIG. 7 shows a block diagram of a circuit designed to compensate for the internal impedance of cells according to one embodiment of the invention;

FIG. 8 shows a schematic depicting a model of a cell that takes into account the internal resistance of the cell according to one embodiment of the invention;

FIG. 9 shows a schematic of a cell balancing circuit according to one embodiment of the invention;

FIG. 10 shows a graph of Open Circuit Voltage (“OCV”) vs. SOC;

FIG. 11 shows a graph of effective impedance vs. SOC; and

FIG. 12 shows a graph demonstrating the decline of cell discharge capacity vs. number of discharge cycles.

### DETAILED DESCRIPTION OF AN EXEMPLARY EMBODIMENT

A battery management system (“BMS”) for optimizing energy usage and availability for a battery pack used in an HEV is described herein. The battery pack described in conjunction with the BMS is merely an illustrative example of a battery pack to which the BMS may be applied and utilized.

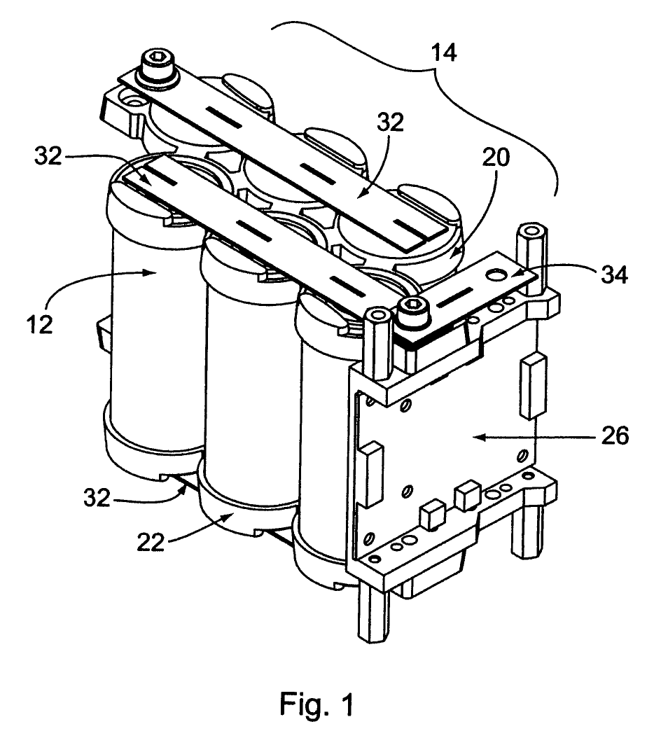

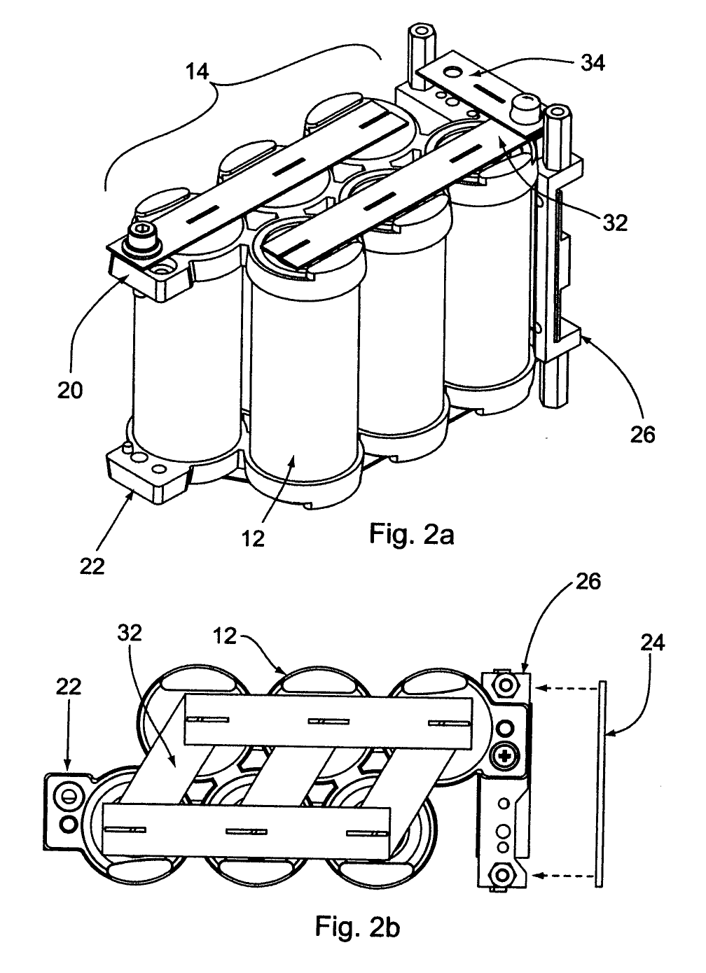

FIG. 1 shows an illustrative isometric view of a module 14 with a printed circuit board mounting plate 26. Modules 14 are comprised of a multiplicity of cells 12, held together between a top cap 20 and a bottom cap 22, which are electrically linked together by cell connectors 32, and to other modules 14 by intermodule connectors 34. As illustrated in FIGS. 2a and 2b, each module 14 in the exemplary embodiment considered herein has six cells. Each module 14 is monitored and regulated by means of electronic circuits on a PCB 24 (shown in FIG. 2b), which is affixed to a PCB mounting plate 26.

FIG. 2a shows an illustrative isometric rear view of the module 14 shown in FIG. 1, whereas FIG. 2b shows a bottom view of the module 14 revealing a different layout of cell connectors 32 than FIG. 2a, and showing where the PCB 24 fits into its mounting plate 26.

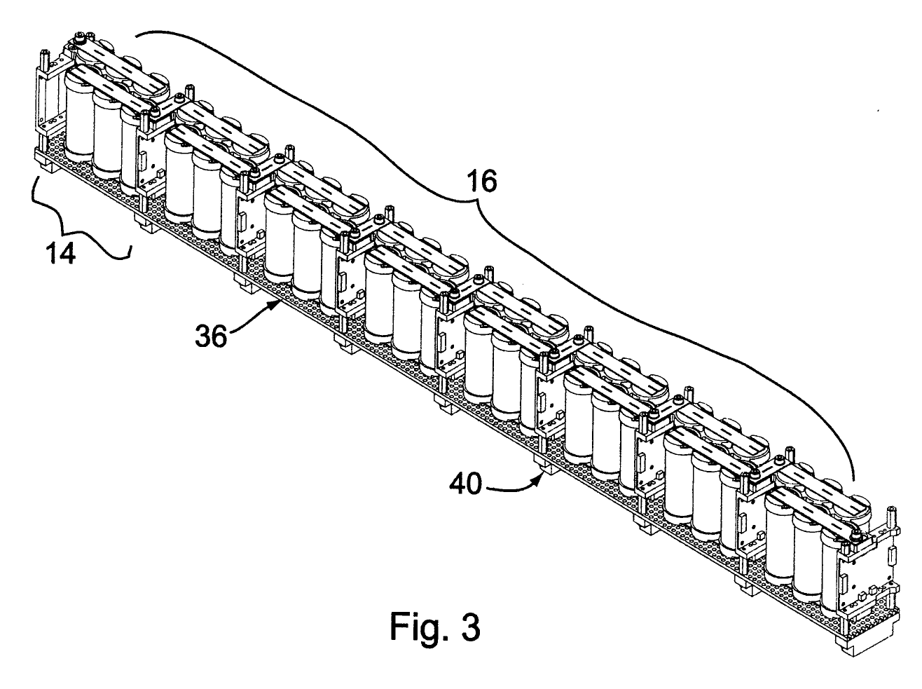

FIG. 3 shows an illustrative isometric view of a bank 16 of modules 14 supported by interlocking bottom rails 40 which support a diffuser 36. The diffuser 36 is used to diffuse air to the modules 14, which helps to prevent the cells from overheating during operation.

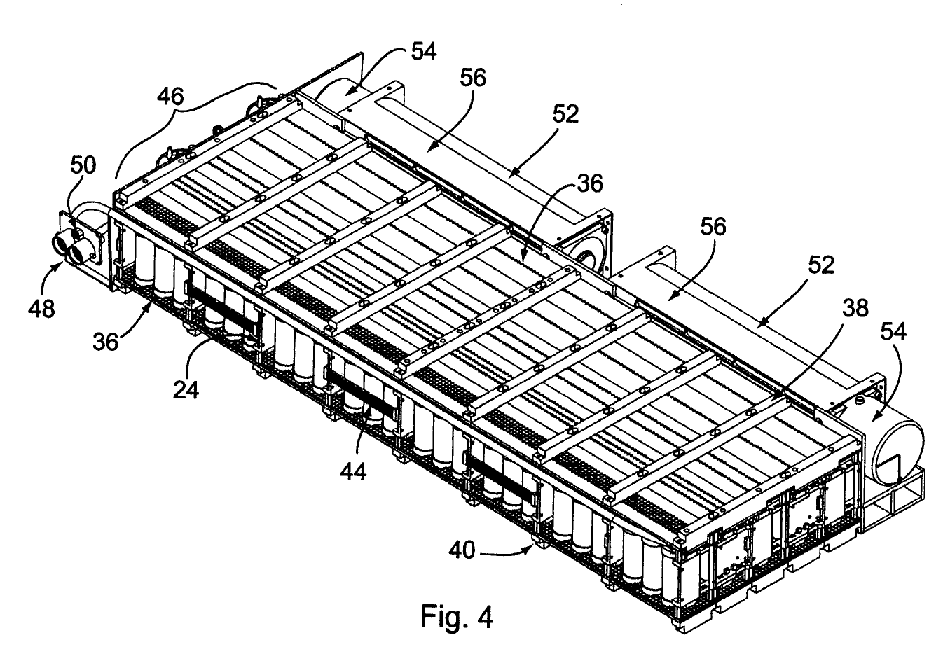

FIG. 4 shows an illustrative isometric rear view of a battery pack 18 which includes a multiplicity of banks, with diffusers 36 supported by bottom rails 40, the pack 18 being fastened together by top rails 38. Modules 14 reveal PCBs 24 inserted into their PCB mounting plates, which are linked together by data connectors 44, which exchange data with the electronic control unit (“ECU”) 72, by means of an ECU interface 50. The ECU 72 is a commercially available, industry standard automotive grade unit. The ECU interface 50 communicates with the vehicle controller via a standard Controller Area Network bus, and can be readily customized for specific platforms. In this fashion, all the PCBs 24 are connected to the ECU 72. Also shown are fans 52 with their motors 54 and mountings 56, along with an electronics bay 46 having power output 48 connectors. The fans 52 are used in conjunction with the diffusers 36 to prevent the battery pack 18 from overheating during use.

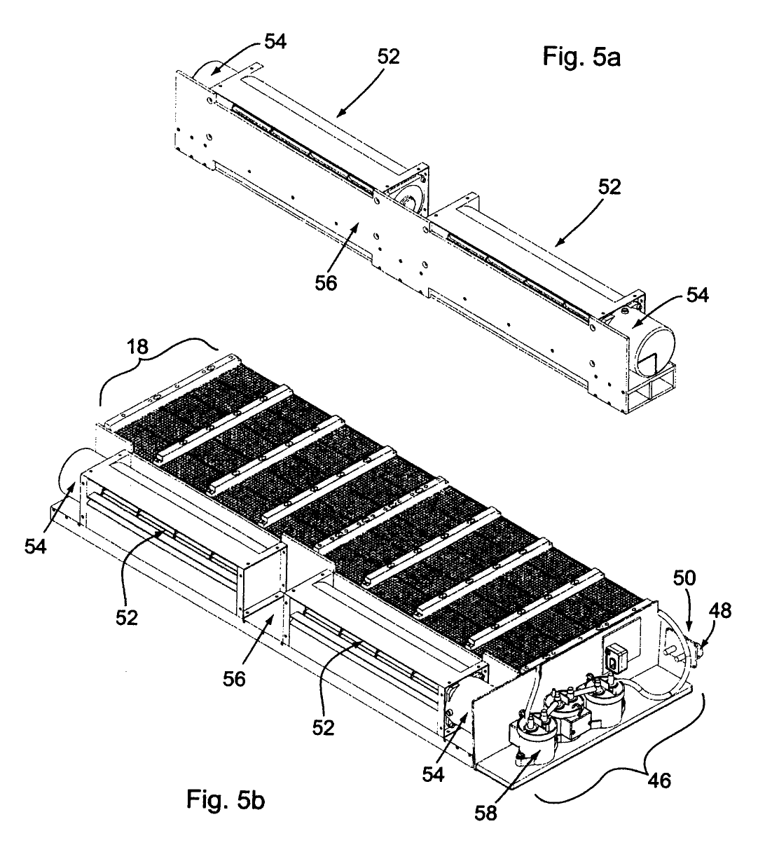

FIG. 5a shows an illustrative isometric rear view of a fan mounting 56 with fans 52, and motors 54.

FIG. 5b shows an illustrative isometric front view of the fan mountings 56, fan 52, and motor 54, on a battery pack 18, and reveals the capacitors 58, power output 48, and ECU interface 50, in the electronics bay 46.

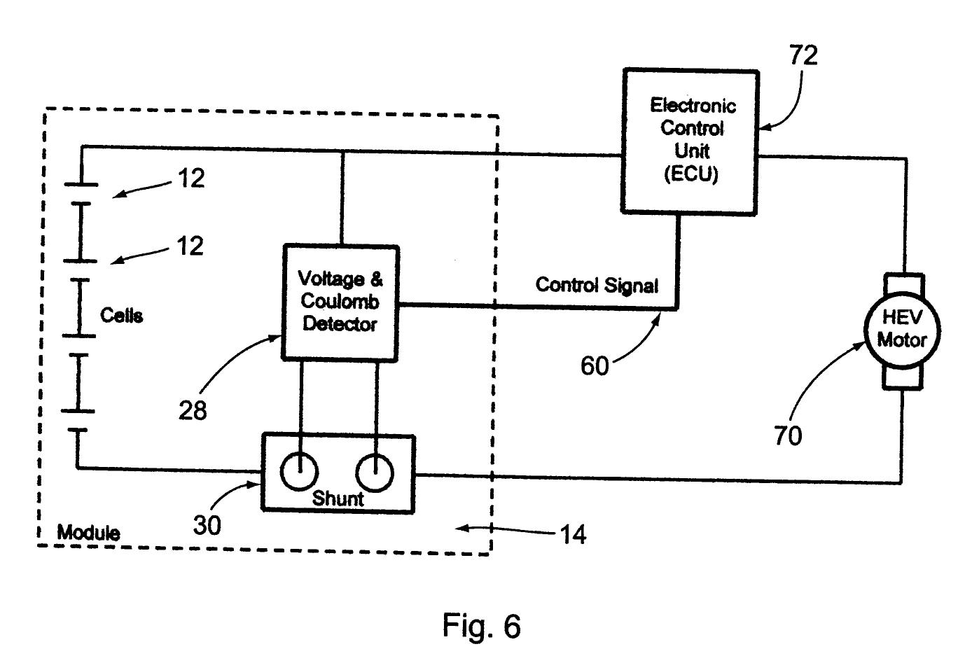

FIG. 6 shows an example of the SoAh analyzer circuitry found on the PCB 24 monitoring the cells 12 of each module 14, and includes a Voltage/Coulomb Detector 28, a shunt resistor 30, and a control signal 60 which may be sent to the ECU 72 which regulates the power supplied to the HEV motor 70. For the purposes of this disclosure, a shunt resistor is a low value resistor used in parallel with a current meter to increase the amount of current the meter can measure.

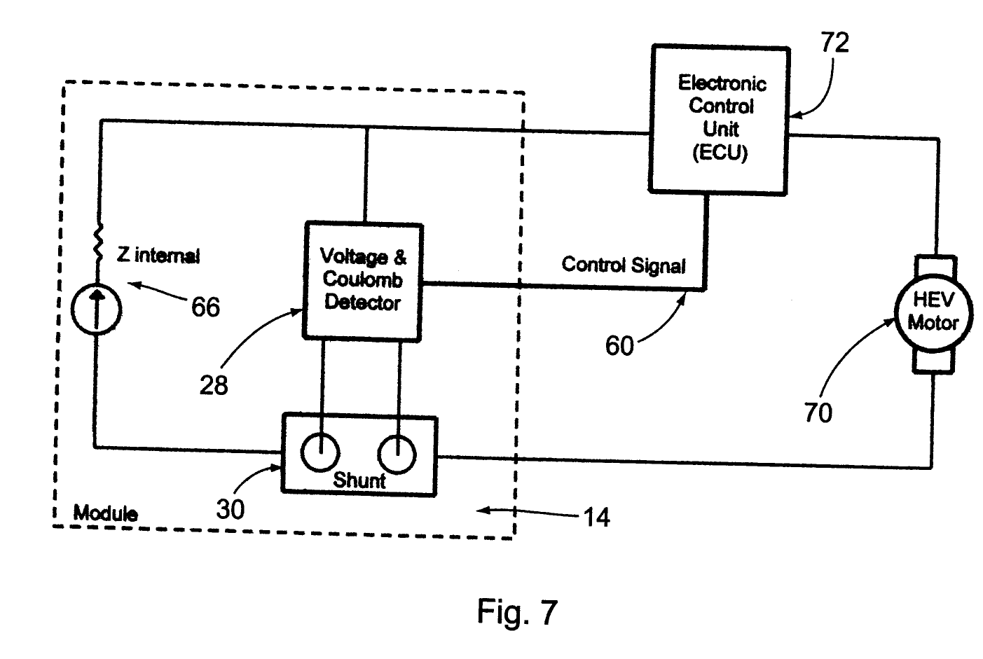

FIG. 7 shows the SoAh analyzer circuitry of FIG. 6 being used to test for power losses due to high equivalent internal impedances 66, which losses become significant when the cells 12 are operated at high currents. It is understood that the capacity (Ah) is nominal, as printed on the battery. Rated capacity decreases with time and the number of charge/discharge cycles.

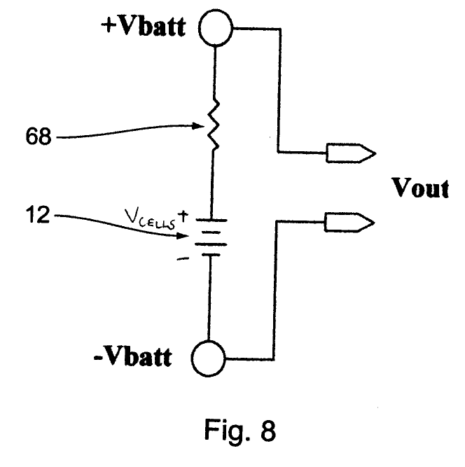

FIG. 8 shows a model of a cell 12 that takes into account the equivalent internal resistance 68 of the cell 12.

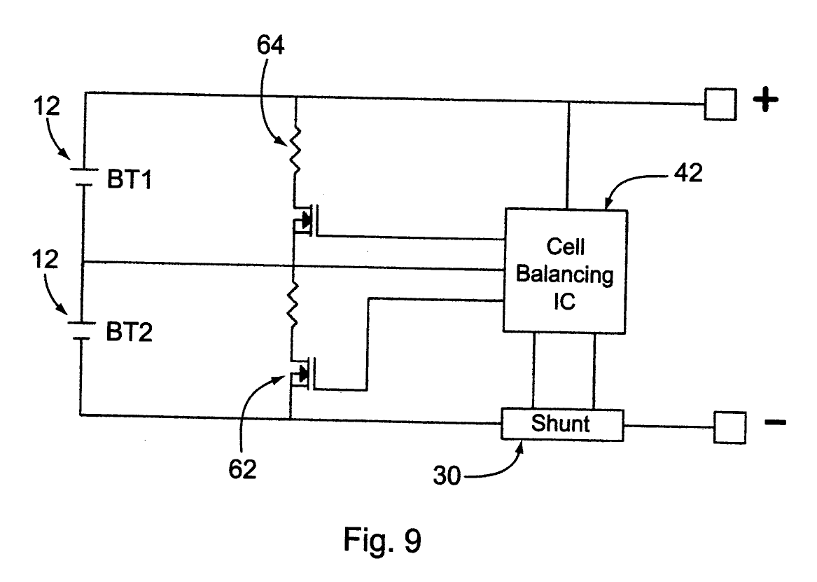

FIG. 9 shows an example of a cell balancing circuit that forms part of the PCB 26 which includes a cell balancing integrated circuit (“IC”) 42, its shunt resistor 30, and a field effect transistor (“FET”) 62 with its load resistor 64, for each cell 12. The cell balancing IC 42 measures the voltage across each cell 12, and conveys these measurements to the ECU 72. The ECU 72 then balances the cells in accordance with the method described, below.

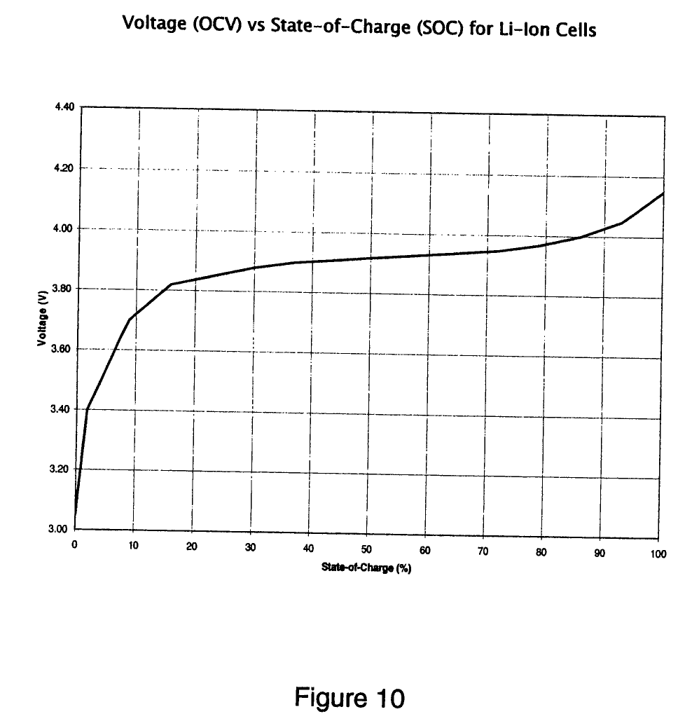

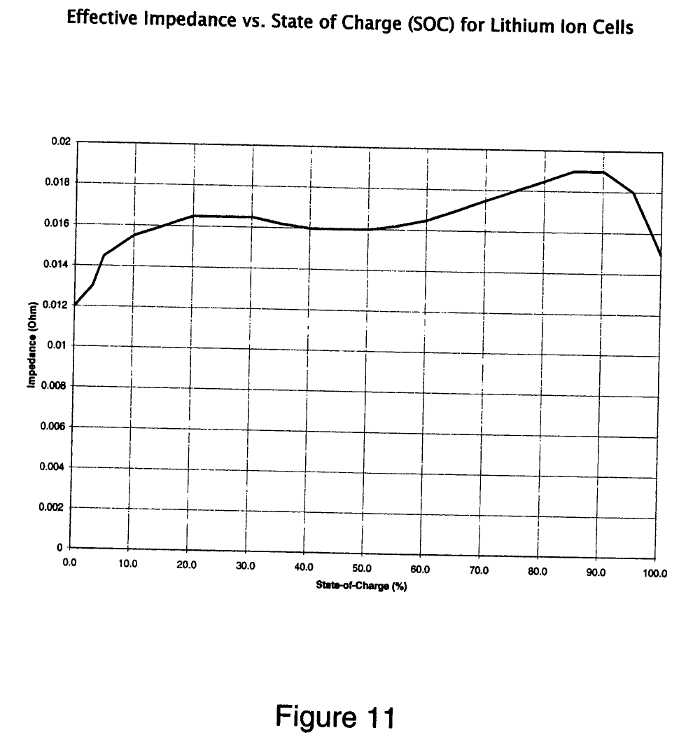

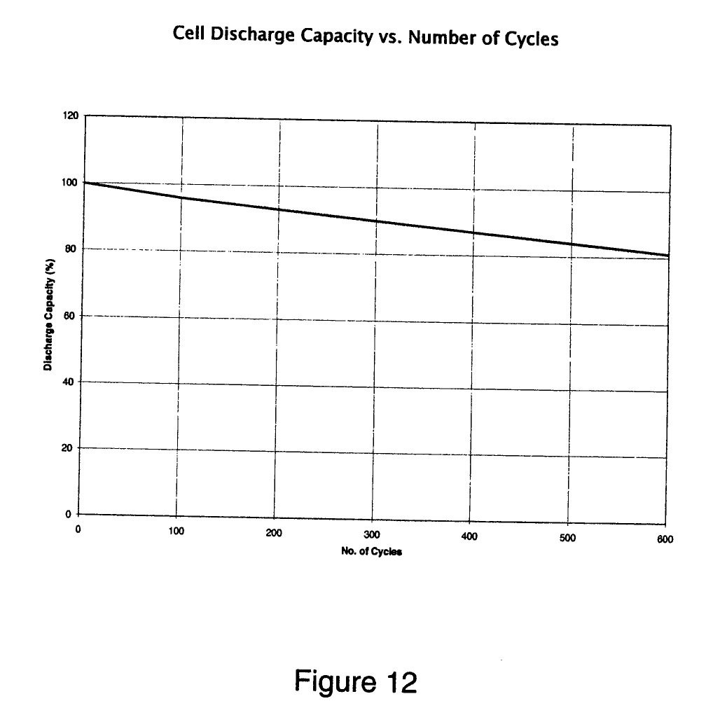

The following graphs validate specific claims made in this disclosure and illustrate: Open Circuit Voltage vs. State of Charge (SOC) (FIG. 10), Effective Impedance vs. State of Charge (SOC) (FIG. 11), and the percentage of cell capacity vs. number of cycles (over time) (% of Maximum capacity vs. number of cycles) (FIG. 12). For the purposes of this disclosure, the SOC is a ratio expressed in percent of the energy remaining in a battery in relation to its rated capacity when full.

One illustrative embodiment of a Battery Management System will now be described. The BMS may include at least one of the following elements or may include all of the following elements which will be described individually in more detail below. Namely, a cell protection system, a State of Capacity (SoAh) Analyzer, SOC Limit Compensation, Impedance Compensation, Voltage Limit Compensation, and Active Cell Balancing.

Module with Integral Cell Protection System

Referring generally to FIGS. 1-5, a battery pack having a plurality of electrically coupled modules 14 is shown. Each module 14 has two rows of three cells 12 each. The three cells 12 in each row are connected in parallel, and the two rows are connected in series. The modules 14 are then connected in series with each other to obtain the voltages required for an HEV. A typical six-cell module 14, for example, has a nominal voltage and capacity of 8.4V and 8.7 Ah, respectively. A typical pack of 40 modules would then have a nominal voltage of 336V and a nominal capacity of 8.7 Ah.

Referring now to FIGS. 6 and 9, each module 14 has an integral cell protection system. A schematic of the cell protection system at the cell level is shown in FIG. 9. The cell protection system comprises an electronic circuit having a cell balancing IC 42 that provides information on the voltage, temperature and current of the cells contained in the module 14. For each module 14 the cell protection system communicates information on the status of the cells 12, such as the cells' 12 current, temperature and voltage, in the module 14 to the central ECU 72. The ECU 72 processes this information and then uses computer programs to determine, for example, the SoAh of the cells 12, the SOC of the cells 12, and other information related to the cells 12. The ECU 72 also provides control signals to the cell balancing IC 42.

### State of Capacity (SoAh) Analyzer

With reference to the illustrative example in FIGS. 6 and 7, an accurate SoAh (effective capacity) reading is important in the operation of an HEV battery pack. Typically, the battery pack should be kept between 20% and 80% of its capacity range to permit discharge during acceleration and charge during braking. The lithium ion battery pack cell is unique in that, as evidenced by FIG. 10, the OCV is directly proportional to its SOC, as expressed as percentage of full charge. However, knowing only the current SOC of a lithium ion cell is insufficient to determine the SoAh of the cell because the cell's capacity changes over time. Therefore, while the SOC can always be determined from the OCV simply with reference to FIG. 10, the SOC does not directly result in knowing the SoAh of the cells, and consequently does not result in knowing the power available for use by the HEV.

In order to relate OCV and SOC to SoAh, a calibration sequence is therefore required, as follows:

At start up, the SOC of each module 14 is determined by measuring their OCVs. The voltage & coulomb detector (“V&C detector”) 28 measures the voltage across the cells 12 that make up the module 14. This results in a first SOC reading (“SOC #1”), expressed as a percentage of total charge of the cells 12. An exemplary V&C detector 28 includes an Agilent HCPL7810 voltage detector and a Tamaura L0105 Hall Effect current sensor.

A controlled discharge is then performed and the coulombs used (the “Discharged Coulombs”) are counted by the V&C detector.

The open circuit voltage (OCV) is then again measured to determine the newly depleted SOC. This results in a second SOC reading (“SOC #2”).

The coulombs counted represent the difference between SOC #1 and SOC #2. This difference can then be calculated to determine the relationship of the cell's SoAh to its SOC. I.e., the total charge of the cells is equal to the following:

Total Capacity=(Discharged Coulombs)/(SOC #1−SOC #2) (1)

After the calibration sequence is performed, the current SoAh of the cell (and its SOC) can be determined by simple coulomb counting.

As can be seen in FIG. 10, the OCV is fairly linear between the 10% capacity level and the 90% capacity level; typically, the SOC #1 and SOC #2 readings are taken from this linear range. The detection circuitry required (see FIG. 6) to calculate the SoAh of a module 14 would typically include a V&C detector 28, the ability to calculate data and a method in which to communicate to the vehicle's ECU 72. In this exemplary embodiment, the V&C detector 28 measures the SOC data and the Discharged Coulombs, and communicates this data via data connectors 44 and the ECU interface 50 to the ECU 72. The ECU 72 performs the calculation expressed in Equation 1.

### SOC Limit Compensation

As the above discussion illustrates, obtaining an accurate SOC reading of a cell is important because an accurate SOC reading is a precursor to obtaining an accurate SoAh measurement. As FIG. 12 illustrates, however, the capacity of a cell decreases over time. For a new battery, a practical range in which to operate the battery is between 20% and 80% capacity, for the reasons discussed above. In order for an aged battery with decreased capacity to deliver the same power and maintain the same performance levels as a new battery does at between 20% and 80% capacity, the capacity operating limits for the aged battery must be adjusted to take into account the change in capacity of the battery. As capacity is proportional to SOC readings, the SOC limits must also accordingly be adjusted.

Additionally, as FIG. 10 shows, the SOC of a cell 12 is determined by reading the OCV of the cell 12. Consequently, in order to be able to determine the SOC of a cell 12, it is important to be able to obtain accurate OCV readings. Accuracy of OCV readings can be impeded by voltage drops over the internal impedance of cells 12. Consequently, in order to obtain accurate SOC readings, the SOC limits must be adjusted to take into account voltage drops over the internal impedance of the cells 12.

With respect to the loss of capacity of cells 12 over time, FIG. 12 illustrates how cell capacity decreases with charge/discharge cycles. As described above, a practical operating range for a battery pack used in an HEV is between 20% and 80% capacity. As a battery ages, however, its ability to retain capacity lessens. This means that the battery's ability to deliver the same power at the 20% and 80% capacity levels will lessen. In order for an aged battery to maintain the same performance levels as a new battery, the capacity operating limits need to be adjusted. This is accomplished by periodic measurement of capacity over time using, for example, the SoAh determination associated with Equation (1) and adjusting the operating limits according to a predetermined performance table.

For example, assume a cell (the “aged cell”) has undergone 600 charge/discharge cycles. With reference to FIG. 12, it is apparent that the capacity of the old cell is roughly 81% that of a cell that has undergone no charge/discharge cycles (the “young cell”). Mathematically, (Capacity of Aged Cell)=(0.81)*(Capacity of Young Cell). Assuming that a typical operating range when using the young cell is 20% to 80% of capacity, this means that the young cell is typically at least 20% of its capacity from being entirely discharged and 20% of its capacity from being entirely charged. Because the capacity of the aged cell is only 81% of the capacity of the young cell, however, 20% of the capacity of the young cell translates to (0.20)/(0.81)=24.7% of the capacity of the aged cell. Consequently, the analogous operating range for the aged cell is between 24.7% and 75.3% as opposed to 20% and 80% for the young cell. Based on FIG. 10, the ECU 72, instead of attempting to maintain OCV of the aged cell between 3.82V and 3.97V (which correspond to 20% and 80% of the capacity of the young cell, respectively), will instead attempt to maintain the OCV of the aged cell between 3.86V and 3.95V (which correspond to 24.7% and 75.3% of the capacity of the aged cell, respectively). The relationship between cell age in terms of number of cycles, cell capacity, and OCV can be stored in look-up tables within the ECU 72 that can be accessed to determine how the SOC values should change over time. While several factors, such as temperature, may affect the capacity of the aged cell over time, the number of charge cycles the aged cell has undergone is the most important.

With current flowing into and out of the aged cell, however, the V&C detector 28 can only read the terminal voltage of the cell and not the OCV of the cell. The ECU 72 can, however, determine what terminal voltages correspond to the OCVs of the cell that in turn correspond to the adjusted capacity levels of the cell. The ECU 72 can do this by taking into account the voltage drop across the internal and connector impedances of the cell. Using the 24.7% and 75.3% range from above, for example, the desired OCVs that define the operating range of the aged cell are 3.86V and 3.95V. Additionally, from FIG. 11, the effective impedances (the sum of internal+connector impedances) at these SOC levels are 16.5 mΩ) and 18 mΩ. Consequently, the terminal voltages at any current level 1, assuming effective impedances of 16.5 mΩ and 18 mΩ, respectively, are 3.65V+I*(16.5 mΩ) and 3.56V+I*(18 mΩ).

### Impedance Compensation

Coulomb counting is an important part of determining a battery cells' capacity and its SOC. However, in an HEV application, large currents occur. These large currents will interact with the cells' internal impedance causing heating and power loss. This power loss is not counted by the external coulomb counter. To ensure accurate coulomb representation, the losses by the cell due to the cells' internal impedance must be calculated and combined with the measured coulomb count. Regardless of which type of battery chemistry is employed (lead acid, nickel metal hydride, or lithium ion), each has its own operating limitations but all have an internal impedance of a value that may affect vehicle operation.

Referring to FIGS. 6 & 7, the typical operation of the coulomb counter is to determine the amount of current drained during discharging and the amount of current accepted during charging. This is accomplished with the use of a current sensing shunt. As power is discharged from the battery, the amount of current discharged over a period of time is measured and subtracted from a previously determined value. In this fashion, the current capacity of the battery is always known. Analogously, during charging, the amount of charge added to a cell over a period of time is measured and added to a previously determined value. In this manner, given that the charging voltage is known, the capacity of the battery is always known.

The SoAh is typically determined by counting the amount of coulombs entering and exiting the battery. An accurate SoAh is important for proper operation of the battery in the HEV. At high current operation, the internal impedance of the battery may cause inaccuracies in the SoAh calculation if it is not compensated for.

Under low current operating conditions, the accuracy of the coulomb counter is acceptable and the internal impedance of the cell has little or no effect. However, when there are large currents present in a battery application, the cell's internal impedance does become a factor in the accuracy in the coulomb count. The power loss due to the internal impedance of the cell is not recorded by the coulomb counter. At lower currents, such power loss is generally insignificant; at higher currents, however, the higher the power losses and the greater the inaccuracy of the coulomb counter.

For example, a battery has an internal impedance of 0.018 ohms. At a discharge current of 40 milliamps, the power loss is (I²×Z=P_{Io})=(0.04)²×0.018=28.8 microwatts. This is a fairly insignificant amount. However, when the discharge current is 40 amps, as can occur during charging that is a result of regenerative braking, the power loss due to the battery's internal impedance is 40²×0.018=28.8 watts. This is a significant amount for the coulomb counter not to count and in some circumstances this inaccuracy in the amount of charge detected could result in damage to the battery. Note that the power loss from the internal impedance of the battery would cause the coulomb counter to indicate more capacity than what is actually stored. Consequently, at high currents, the current reading at any given time can be transmitted to the ECU 72, which has stored the internal impedance of the cells 12 and which can consequently calculate the power loss over the internal impedance of the cells 12 and adjust the capacity of the battery accordingly to ensure that the capacity of the battery is accurately represented.

For example, assume that a cell is being charged at a current of 40 A at a terminal voltage of approximately 4.0V. Assuming an internal impedance of 18 mΩ, this means that approximately 0.72V is dropped over the internal impedance of the cell and that only 3.28V is used to charge the cell itself. As power is directly proportional to voltage, this means that (0.72/3.28)=22% of the power is dissipated in the form of heat as opposed to being used to charge the energy. Consequently, for any given charging time, the actual amount of energy stored by the battery is 22% lower than the amount of energy that would be stored by an ideal battery with no internal impedance. Consequently, the ECU 72 can decrease the capacity of the battery by 22%.

### Voltage Limit Compensation

Referring now to FIG. 8, we see a schematic of a pair of non-ideal cells 12. The non-ideal nature of the cells 12 is evident by the presence of an internal resistance (Rᵢₙₜₑᵣₙₐₗ) 68, which represents the internal resistance of the cells 12. For a typical lithium ion cell, and as evidenced by FIG. 11, Rᵢₙₜₑᵣₙₐₗ varies from 16 milliohms at 10% state-of-charge to 20 milliohms at 90% state-of-charge. Rᵢₙₜₑᵣₙₐₗ is almost entirely made up of the resistance of the materials used to make the cell.

V_{UL} (upper voltage limit) and V_{LL} (lower voltage limit) are parameters that have been determined for the safe operation of lithium ion cells. Typically, both V_{UL} and V_{LL} are measured across the terminals of a cell, as Vₒᵤₜ is in FIG. 8. Ideally, however, and again referring to FIG. 8, V_{UL} and V_{LL} are measured across the cell 12 only, as V_{cells} is. V_{UL} is typically 4.2 volts and V_{LL} is typically 2.5 volts.

At low and moderate currents, the voltage drop across Rᵢₙₜₑᵣₙₐₗ is relatively insignificant, and Vₒᵤₜ≈V_{cells}. At the very high currents that can occur in an HEV, however, a significant voltage drop can occur across Rᵢₙₜₑᵣₙₐₗ and Vₒᵤₜ can differ drastically from V_{cells}. The large currents will cause Vₒᵤₜ to be larger (in the case of cell charging) or smaller (in the case of cell discharging) than V_{cells}. As V_{UL} and V_{LL} can only be measured at the cells' 12 terminals, the voltage drop across Rᵢₙₜₑᵣₙₐₗ can unnecessarily limit the operating range of the cell 12. To compensate for this, the voltage drop across Rᵢₙₜₑᵣₙₐₗ can be calculated and added or subtracted from V_{UL} and V_{LL}.

For the sake of illustration, presume Rᵢₙₜₑᵣₙₐₗ 68 is 18 milliohms and V_{cells} is 4 volts. If a load of 1 A (I_{load}) were to be placed across the terminals of the cells 12 then Vₒᵤₜ would be V_{cells}−(I_{load}*Rᵢₙₜₑᵣₙₐₗ)=Vₒᵤₜ or 4V−(1 A* 0.018 f))=3.982V. This represents only a 0.45% voltage loss across Rᵢₙₜₑᵣₙₐₗ and can be considered minimal.

A load of 10 amps would result in a Vₒᵤₜ of 4V−(10 A*0.018Ω)=3.82V or a voltage loss of 4.5% across Rᵢₙₜₑᵣₙₐₗ. In most cases this difference between V_{cells} and Vₒᵤₜ would still be acceptable in that no compensation for the voltage drop across Rᵢₙₜₑᵣₙₐₗ would have to be performed. At a load of 100 Amps, however, Vₒᵤₜ=4V−(100 A*0.018Ω)=2.2V, which represents a voltage drop across Rᵢₙₜₑᵣₙₐₗ of 45%. This is a significant loss of almost half of the available voltage.

With most non-lithium ion battery chemistries (e.g. lead acid, nickel cadmium, nickel metal hydride), the cell 12 would still be useable, albeit at a reduced performance level. With a lithium ion cell level, however, V_{LL} is set at 2.5V Consequently, a 100 A load would instantly cause Vₒᵤₜ to be below V_{LL} and the ECU 72 would cease using the cell 12 so as to avoid damaging it, notwithstanding that V_{cells} would be an acceptable 4 V.

In order to compensate for the effect of voltage drop across Rᵢₙₜₑᵣₙₐₗ that results from the high current flow, V_{UL} and V_{LL} can be modified based on the amount of current flow. For example: a current of 100 amps flowing through the battery's internal resistance would cause a drop of 1.8 volts across Rᵢₙₜₑᵣₙₐₗ. If V_{LL} were originally set at 2.5 volts for the situation where the voltage drop across Rᵢₙₜₑᵣₙₐₗ is insignificant, then the modified V_{LL} to take into account a current of 100 amps would be 0.7 volts. The ECU 72, knowing the amount of current by virtue of V&C detector 28. The same would hold true for the upper voltage limit. If the upper voltage was set at 4.2V for the situation where the voltage drop across Rᵢₙₜₑᵣₙₐₗ is insignificant, then the new voltage limit with a current flowing of 100 amps would be 6 volts.

### Active Cell Balancing

Permitting Active Cell Balancing in a Battery String:

To ensure consistent performance from all cells in a multi-cell series-connected string, a system must be in place to equalize the voltage of each cell in that string. As the cells used to make a pack are typically all from the same manufacturing batch, they will have similar capacities and therefore balancing the cells' voltages will also balance their capacities. If such equalization is not done on a consistent basis then there is a possibility for the cells to become unbalanced to an extent that makes the module/battery pack unusable. The danger of having unbalanced cells is that in the case of unbalanced cells that have unequal capacity, the cell with the least capacity will discharge before the other cells to which it is connected in series and consequently cause the whole pack to shut down. Active cell balancing is accomplished by measuring the voltage of each cell in the string and calculating a reference voltage, V_{REF}, from such voltage measurements. If one cell is determined to have a higher voltage than V_{REF} then a small resistive load is placed across that cell. When the voltage of that cell becomes equal to V_{REF} become equal then the load is removed.

A block diagram of a cell balancing circuit is illustrated in FIG. 9. The voltages of cells BT1 and BT2 are measured during low or zero current flow. In one embodiment, V_{REF} is set equal to the average voltage of the cells. In such an embodiment, for N cells, the average voltage is then calculated using (V_{BT1}+V_{BT2}+ . . . +V_{BTN})÷N. So, for the circuit of FIG. 9, if V_{BT1}=4.0V and V_{BT2}=3.9V then the average voltage is V_{AVE}=(4.0V+3.9V)÷2=3.95V. The ECU 72 would then turn on the load across BT1. When V_{BT1}=V_{AVE} then the ECU 72 would turn off the load across BT1. This process is continually performed at any SOC until all cell voltages are equal.

Alternatively, according to another embodiment of the invention, instead of calculating the average voltage of N cells, the lowest voltage of any of the N cells can be used as V_{REF}. Then, in order to balance the cells, the ECU 72 can discharge any cell having a voltage higher than that of the lowest cell until its voltage reaches that of the lowest cell. With reference to FIG. 9, for example, if V_{BT1}=4.0V and V_{BT2}=3.9V, the ECU 72 would turn on the load across BT1 until V_{BT1}=V_{BT2}. When V_{BT1}=V_{BT2}, the ECU 72 would turn off the load across BT1. This process is continually performed at any SOC until all cell voltages are equal.

Beneficially, this cell balancing process can be performed at any SOC and through all voltage levels, and whether the cell is being charged or discharged. Such cell balancing is usually done between 10% and 90% SOC, when the relationship between OCV and SOC of the cell is approximately linear.

The battery management system described herein may also apply to underwater autonomous vehicles, solar energy systems, backup power, stationary power systems, and consumer power supplies.

The present invention has been described with regard to a plurality of illustrative embodiments. However, it will be apparent to persons skilled in the art that a number of variations and modifications can be made without departing from the scope of the invention as defined in the claims.

1. A battery management system for determining a state of capacity of a lithium ion cell comprising:
a) a voltage detector coupled to the cell for obtaining first and second terminal voltage measurements of the cell;
b) a coulomb detector coupled to the cell for counting the number of coulombs discharged from the cell during a controlled discharge of the cell that occurs between the first and second terminal voltage measurements;
c) an electronic control unit coupled to the voltage and coulomb detectors, the electronic control unit calculating the state of capacity of the cell from the number of coulombs discharged from the cell during the controlled discharge and from the first and second terminal voltage measurements of the cell.

2. A battery management system as claimed in claim 1 wherein the terminal voltage measurements are open circuit terminal voltage measurements.

3. A method of determining a state of capacity of a lithium ion cell comprising:
a) determining a first state of charge of the cell;
b) performing a controlled discharge of the cell;
c) counting charge discharged from the cell during the controlled discharge;
d) determining a second state of charge of the cell; and
e) calculating the state of capacity of the cell based on the charge discharged from the cell during the controlled discharge and on the difference between the first state of charge and the second state of charge.

4. A method of determining a state of capacity of a lithium ion cell as claimed in claim 3 wherein the steps of determining the first and second states of charge of the cell are accomplished by reading first and second open circuit voltages of the cell and correlating the first and second open circuit voltages to the first and second states of charge, respectively.

5. A method of determining a state of capacity of a lithium ion cell as claimed in claim 4 wherein the step of calculating the state of capacity of the cell comprises determining the total capacity of the cell using the following equation:
Total Capacity=(Charge Discharged During Controlled Discharge)/[(First State of Charge)−(Second State of Charge)]

6. A battery management system for balancing the state of charge of cells in series of a battery pack, the system comprising:
a) a voltage detector coupled to the cells for measuring a voltage of each cell of the battery pack;
b) a switch in communication with a selected cell for allowing current to flow from the selected cell of the battery pack;
c) a load resistor in communication with the selected cell for receiving the current flow from the selected cell; and
d) a cell balancing integrated circuit in communication with the voltage detector, the switch and the load resistor, the cell balancing integrated circuit calculating a reference voltage of the cells of the battery pack VREF based on the measured voltage of each cell, determining which cell of the battery pack has a higher voltage than VREF, and discharging the cell with a higher voltage than VREF by closing the switch associated with the cell that has a higher voltage than VREF until the voltage of cell that has a higher voltage than VREF has a voltage substantially equal to VREF.

7. A system as claimed in claim 6 wherein the switch is a transistor.

8. A system as claimed in claims 7 wherein the electronic control unit discharges the cell that has a higher voltage than V_{REF} when a capacity of the battery pack is between 10% and 90%.

9. A system as claimed in claim 8 wherein V_{REF} is an average voltage of the cell of the battery pack.

10. A system as claimed in claim 8 wherein V_{REF} is a lowest voltage of the cells of the battery pack.

11. A method of balancing the state of charge of cells in series of a battery pack comprising the steps of:
a) measuring the voltage of each cell in the battery pack;
b) determining a reference voltage of the cells of the battery pack VREF; and
c) discharging any cell which has a voltage higher than VREF on to a load until the voltage of that cell is substantially equal to VREF.

12. A method as claimed in claim 11 wherein the step of discharging any cell which has a voltage higher than V_{REF} is performed when the capacity of the battery pack is between 10% and 90%.

13. A system as claimed in claim 12 wherein V_{REF} is an average voltage of the cell of the battery pack.

14. A system as claimed in claim 12 wherein V_{REF} is a lowest voltage of the cells of the battery pack.

15. A battery management system for adjusting the state of charge limits on a lithium ion cell comprising
a) a voltage detector coupled to the cell for measuring a terminal voltage of the cell; and
b) an electronic control unit in communication with the voltage detector, the electronic control unit determining an operating range of the cell and calculating the terminal voltages that correspond to the operating range.

16. A method of adjusting the state of charge limits on a lithium ion cell comprising
a) obtaining an operating range of a lithium ion cell; and
b) adjusting the terminal voltage of the cell to correspond to the operating range.

17. A battery management system for adjusting an upper voltage limit VUL and a lower voltage limit VLL of a lithium ion cell, the system comprising:
a current detector in communication with the cell for measuring the current flowing through the cell ICELL; and
an electronic control unit in communication with the current detector, the electronic control unit having the internal resistance of the cell Rinternal, VUL and VLL, the electronic control unit calculating a modified upper voltage limit VUL′ and a modified lower voltage limit VLL′ from VUL, VLL, ICELL, and Rinternal.

18. A battery management system as claimed in claim 17 wherein the cell is being charged and the electronic control unit calculates V_{UL}′ and V_{LL}′ using the following equations
VUL′=VUL+(Rinternal)*ICELL
VLL′=VLL+(Rinternal)*ICELL

19. A battery management system as claimed in claim 17 wherein the cell is being discharged and the electronic control unit calculates V_{UL}′ and V_{LL}′ using the following equations
VUL′=VUL−(Rinternal)*ICELL
VLL′=VLL−(Rinternal)*ICELL

20. A method of adjusting an upper voltage limit V_{UL} and a lower voltage limit V_{LL} of a lithium ion cell comprising the steps of
a) measuring the current flowing through the cell ICELL;
b) calculating a modified upper voltage limit VUL′ and a modified lower voltage limit VLL′ from VUL, VLL, ICELL, and a known internal resistance of the cell Rinternal.

21. A method as claimed in claim 20 wherein the cell is being charged and the step of calculating a modified upper voltage limit V_{UL}′ and a modified lower voltage limit V_{LL}′ utilizes the following equations
VUL′=VUL+(Rinternal)*ICELL
VLL′=VLL+(Rinternal)*ICELL

22. A method as claimed in claim 20 wherein the cell is being discharged and the step of calculating a modified upper voltage limit V_{UL}′ and a modified lower voltage limit V_{LL}′ utilizes the following equations
VUL′=VUL−(Rinternal)*ICELL
VLL′=VLL−(Rinternal)*ICELL

23. A battery management system for modifying a capacity of a lithium ion cell based on current flowing through the cell, the battery management system comprising:
a current detector for measuring the current flowing through the battery pack I;
an electronic control unit having the internal impedance of the battery pack Z, the electronic control unit calculating power loss Plo as a result of Z using formula II
I2×Z=Plo (II); and
the electronic control unit adapted to decrease the capacity of the cell by an amount proportional to Plo.

24. A method of modifying a capacity of a lithium ion cell based on current flowing through the cell, the method comprising the steps of:
a) measuring the current flowing through the cell I;
b) calculating power loss Plo based on a known internal impedance of the battery pack Z, using formula 11
I2×Z=Plo (II); and
c) decreasing the capacity of the cell by an amount proportional to Plo.
